(19) United States
(12) Patent Application Publication
(10) Pub. No.: US 2003/0142063 A1
(43) Pub. Date: Jul. 31, 2003

(54) Display panel transmission structure capable of multidirectionally adjusting observation angle of the display panel

(76) Inventors: Tony Wang, Hsichih City (TW); Kuo-Hua Tsai, Taipei (TW); Shih-Ho Huang, Chungho City (TW)

Correspondence Address: BRUCE H. TROXELL, SUITE 1404, 5205 LEESBURG PIKE, FALLS CHURCH, VA, 22041, US

(21) Appl. No.: 10/055,879

(22) Filed: Jan. 28, 2002

(51) Int. Cl. G09G 5/00

(52) U.S. Cl. 345/156

(57) ABSTRACT

Display panel transmission structure capable of multidirectionally adjusting observation angle of the display panel, including a housing, a display panel and a transmission mechanism. The housing defines a layout space in which the display panel and the transmission mechanism are movably received. The display panel is drivingly pivotally connected with the transmission mechanism. The transmission mechanism is composed of several gear sets mounted on a base seat and driven by motors. A first gear set serves to drive the display panel to swing forward downward or backward upward. A second and a third gear sets are respectively engaged with racks and slide channels disposed in the housing for extending the display panel out of the housing or retracting the display panel into the layout space of the housing. After the display panel is extended out of the housing, by means of the two gear sets, the display panel is swung leftward or rightward.

### BACKGROUND OF THE INVENTION

The present invention is related to a display panel transmission structure capable of multidirectionally adjusting observation angle of the display panel. The transmission mechanism is in-built in the housing for driving the display panel to extend out of the housing or retract into the housing. After the display panel is extended out of the housing, the display panel can be further swung leftward or rightward or forward downward or backward upward. Accordingly, the observation angle of the display panel can be multidirectionally adjusted.

A conventional display panel is manually mounted on a supporting stand. For example, Taiwanese Patent No. 381803 discloses a measure for connecting a display panel on a supporting stand. The measure includes a display panel, a supporting unit, a mechanical rotary shaft unit and a stepping motor. The supporting unit provides a fixing position where the display panel is fixed. The rotary shaft is composed of a semispherical claw and a funnel-shaped bracket connected therewith. The rotary shaft is connected to back side of the display panel. The central bearing of the bracket is connected with the stepping motor. The stepping motor is mounted on the supporting unit to electrically drive the bracket to rotate. The semispherical claw is driven to rotate the tubular shaft so as to rotate the display panel and adjust observation angle thereof.

The above structure has some shortcomings as follows:

1. In use, normally, the supporting stand must be fixed at a fixed position in car, such as upper side of instrument board of the car. When not used, the display panel cannot be stored.

2. The above structure is complicated. In addition, in order to facilitate observation of the display panel, the display panel is supported at a certain height so that it will occupy much room. In the case that the supporting stand and the display panel are mounted on the upper side of instrument board of the car (inner side of windshield), a driver will be unable to fully see the right front side of the car.

In order to solve the above problem, a retractable and burglarproof display panel structure has been developed, which can be hidden when not used. For example, Taiwanese Patent No. 265920 discloses a retractable display panel structure including a case, slide blocks and main and subsidiary slide rails. The display panel is received in the case and via the slide blocks slidably mounted on the main and subsidiary slide rails. A power source, a reducing unit and a driving gear are drivingly disposed in the case to push the display panel out of the case and swing the display panel up or down.

The above retractable display panel still has a shortcoming as follows: The display panel can be only extended out of the case or retracted into the case. The observation angle of the above display panel cannot be multidirectionally adjusted. Therefore, it is still inconvenient for a user to clearly see the display panel.

### SUMMARY OF THE INVENTION

It is therefore a primary object of the present invention to provide a display panel transmission structure capable of multidirectionally adjusting observation angle of the display panel. The transmission structure includes a housing, a display panel and a transmission mechanism. The housing is composed of an upper casing and a lower casing. A main circuit control board is received in a receiving space of the upper casing. The upper and lower casings define a layout space in which the display panel and the transmission mechanism are movably received. One side of the display panel is drivingly pivotally connected with the transmission mechanism. The transmission mechanism is composed of a first, a second and a third gear sets mounted on a base seat. Each gear set is directly or indirectly controlled and driven by at least one motor to drivingly operate multiple gears. The first gear set is engaged with a gear disposed in the display panel, whereby under control the main circuit, the display panel can be extended out of the housing and then swung forward downward or backward upward. The second and third gear sets are respectively movably engaged with the racks and slide channels of the lower casing. Under control of the main circuit, the gear sets can clockwise and counterclockwise rotate so as to extend the display panel out of the housing or retract the display panel into the layout space of the housing.

After the display panel is extended out of the housing, the main circuit controlling the motor of the second or third gear set to micro-rotate and make the display panel swing leftward or rightward. Therefore, the observation angle of the display panel can be multidirectionally adjusted.

It is a further object of the present invention to provide the above display panel transmission structure capable of multidirectionally adjusting the observation angle of the display panel, in which a sensing unit is disposed between the gear sets. The sensing unit includes multiple sensory gears and circuit elements. The sensory gears serve to detect the rotational state of the gear sets and via the circuit elements send the signal to the main circuit control board to provide true position of the display panel.

The present invention can be best understood through the following description and accompanying drawings wherein:

### BRIEF DESCRIPTION OF THE DRAWINGS

FIG. 1 is a perspective assembled view of the present invention, showing that the display panel is extended out of the housing;

FIG. 2 is a perspective exploded view of the present invention;

FIG. 3 is a perspective view of the display panel, transmission mechanism and housing of the present invention;

FIG. 4 is a view according to FIG. 3, seen from the other side;

FIG. 5 shows that the display panel of the present invention is retracted into the housing;

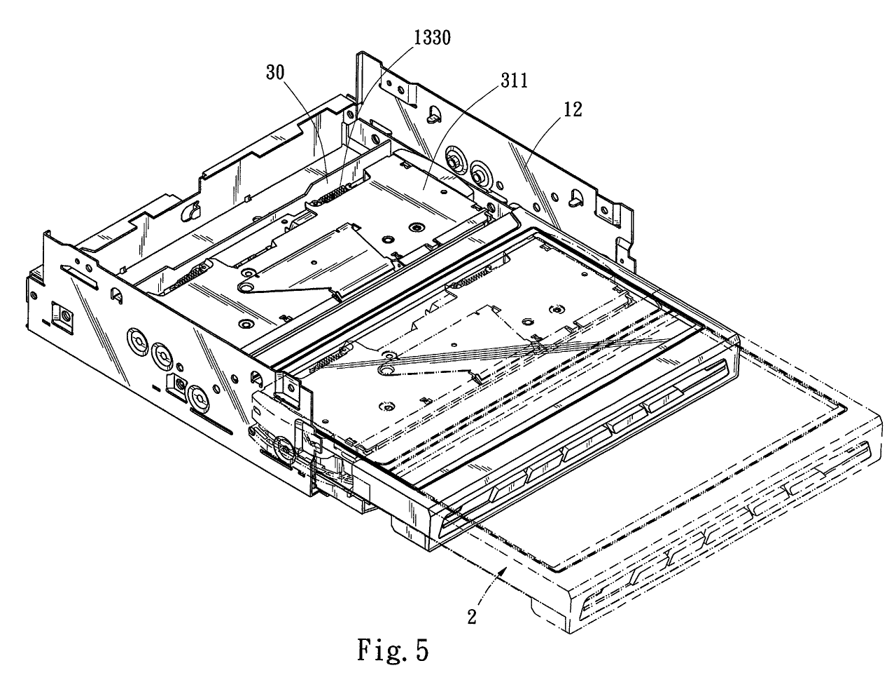

FIG. 6 is a perspective view of the lower casing and base board of the present invention;

FIG. 7 is a perspective view of the transmission mechanism of the present invention;

FIG. 8 shows the components of the first gear set of the present invention;

FIG. 9 shows that the display panel and transmission mechanism of the present invention are received in the housing;

FIG. 10 shows that the display panel of the present invention is extended out of the housing;

FIG. 11 shows that the display panel of the present invention is retracted into the housing;

FIG. 12 shows that the display panel of the present invention is turned outward;

FIG. 13 shows that the display panel of the present invention is turned leftward;

FIG. 14 shows that the display panel of the present invention is turned rightward; and

FIG. 15 shows that the display panel of the present invention is extended out of the housing and resiliently slightly swung upward by the resilient member.

### DETAILED DESCRIPTION OF THE PREFERRED EMBODIMENT

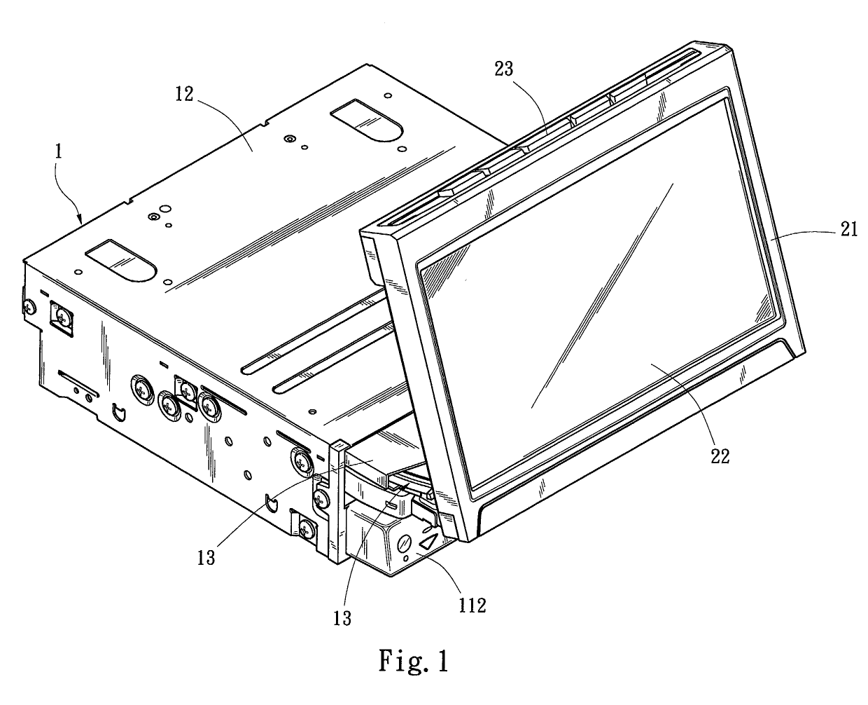

Please refer to FIG. 1. The present invention includes a housing 1, a display panel 2 and a transmission mechanism 3 received in the housing 1 and connected with the display panel 2.

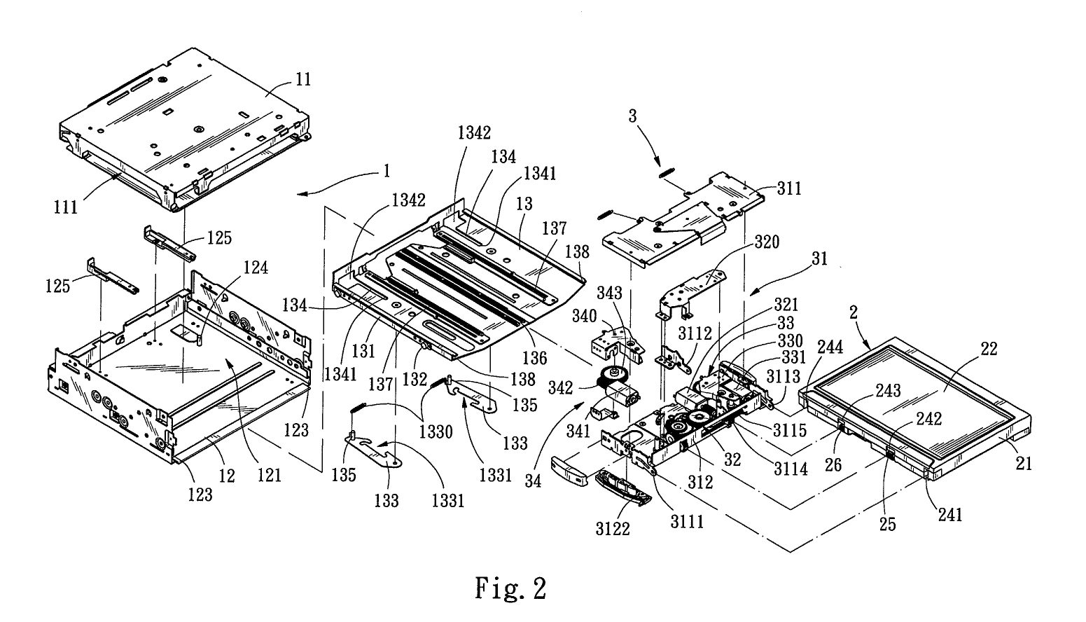

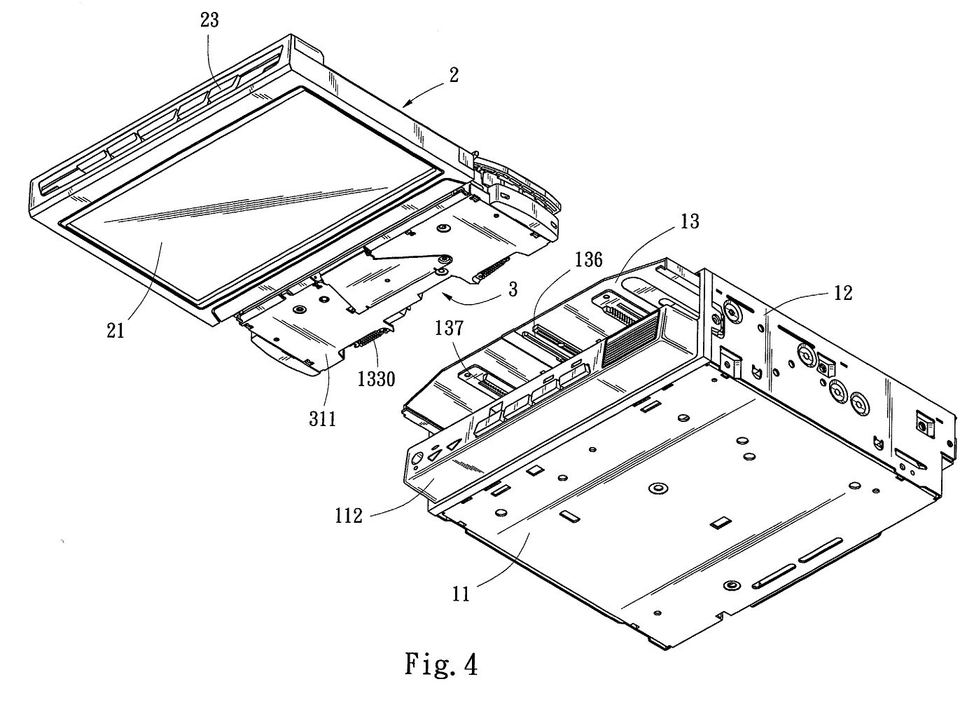

Please refer to FIGS. 2, 3 and 4. The housing 1 is composed of an upper casing 11 and a lower casing 12. The upper casing 11 is a case defining therein a receiving space 111 in which a main circuit control board (not shown) is disposed. A control panel 112 is disposed at one end of the receiving space 111 and connected with the main circuit board for a user to touch and control the functions of the display panel 2. The upper casing 11 is mounted on an upper open side of the lower casing 12. The upper and lower casings 11, 12 define therebetween a layout space 121. The lower casing 11 is formed with a slot 122 on the same side as the control panel 112 of the upper casing 11. The layout space 121 provides an area permitting the display panel 2 and the transmission mechanism 3 to move outward or inward through the slot 122.

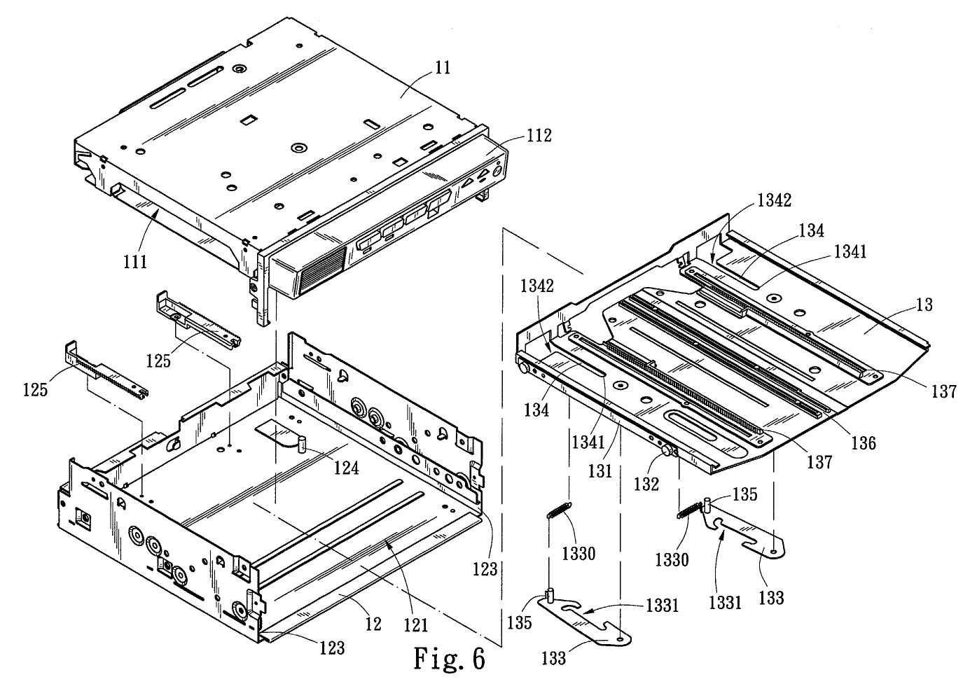

Referring to FIGS. 2 and 6, the present invention further 10 includes a base board 13 corresponding to the lower casing 12. Two sides of the base board 13 are formed with ribs 131 on which slide blocks 132 are disposed. Two sides of the lower casing 12 are formed with slide channels 123 corresponding to the slide blocks 132 for guiding the same. The slide blocks 132 are movable within the slide channels 123, whereby the base board 13 can slide along the slide channels 123. Two opposite hook bodies 133 are pivotally disposed on lower side of base board 13 and pulled by resilient members 1330 to keep in an inward biased state. The inner side of each hook body 133 is formed with a restricting guide notch 1331. The base board 13 is formed with guide slots 134 corresponding to and overlapping the guide notches 1331. Each guide slot 134 has a close end 1341 and an open end 1342. The lower casing 12 is formed with locating posts 124 respectively corresponding to the sliding positions of the guide notches 1331 and guide slots 134.

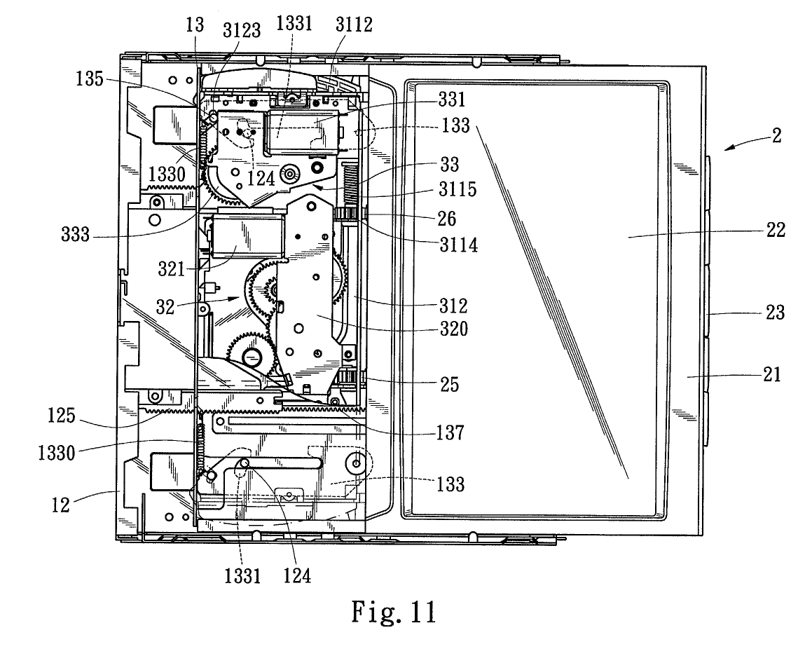

Referring to FIG. 11, when the base board 13 is slided and retracted into the housing 1, the close ends 1341 of the guide slots 134 abut against the locating posts 124 to restrict the base board 13.

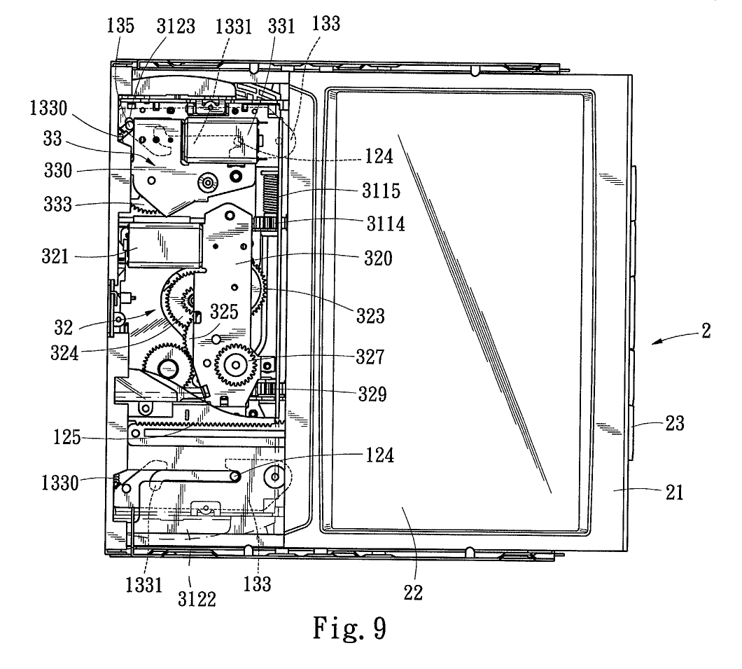

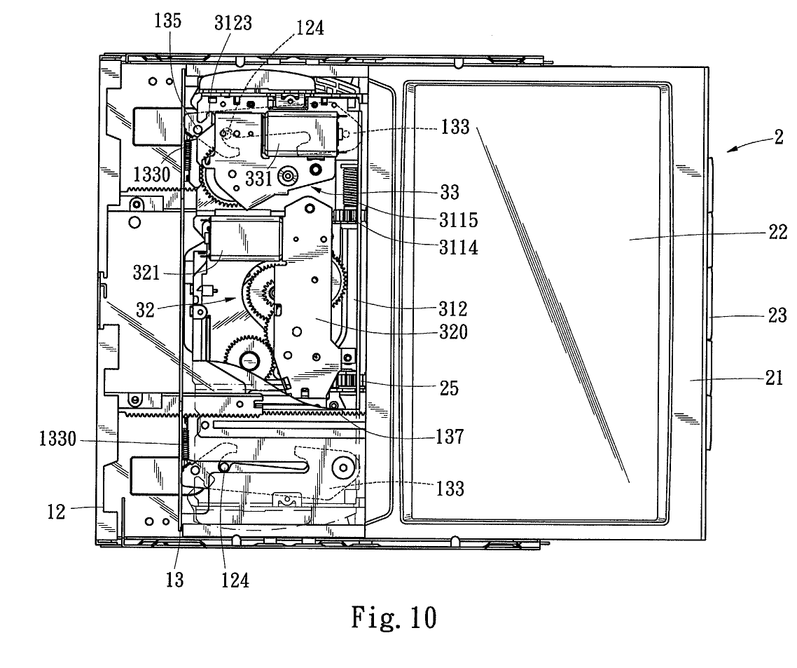

Referring to FIGS. 9 and 10, when the base board 13 is slided outward from the housing 1 and the open ends 1342 are moved to get close to the locating posts 124, the guide notches 1331 of the hook bodies 133 instantaneously hook and locate the locating posts 124. Each hook body 133 has a press post 135. By means of shifting the press posts 135 in a direction reverse to the hooking direction, the locating posts 124 are released from the hooking of the hook bodies 133.

Referring to FIGS. 6 and 9, the middle of top face of the base board 13 is provided with a guide channel 136. Two opposite racks 137 are parallelly disposed on two sides of the guide channel 136. Two other racks 125 are disposed on the lower casing 12 corresponding to the two racks 137. The racks 125 can extend out from the base board 13 and overlap the racks 137 to cooperatively extend the travel.

Referring to FIGS. 2, 3 and 4, the display panel 2 is composed of a frame body 21 and a liquid crystal unit 22 disposed at the center of the frame body 21. The top of the display panel 2 is provided with multiple keys 23 for a user to touch and control the extension/retraction of the display panel 2. The bottom of the display panel 2 is formed with four sets of pivot holes 241, 242, 243, 244. The transmission mechanism 3 is pivotally connected at the pivot holes 241, 242, 243. Gears 25, 26 are mounted at the pivot holes 242, 243.

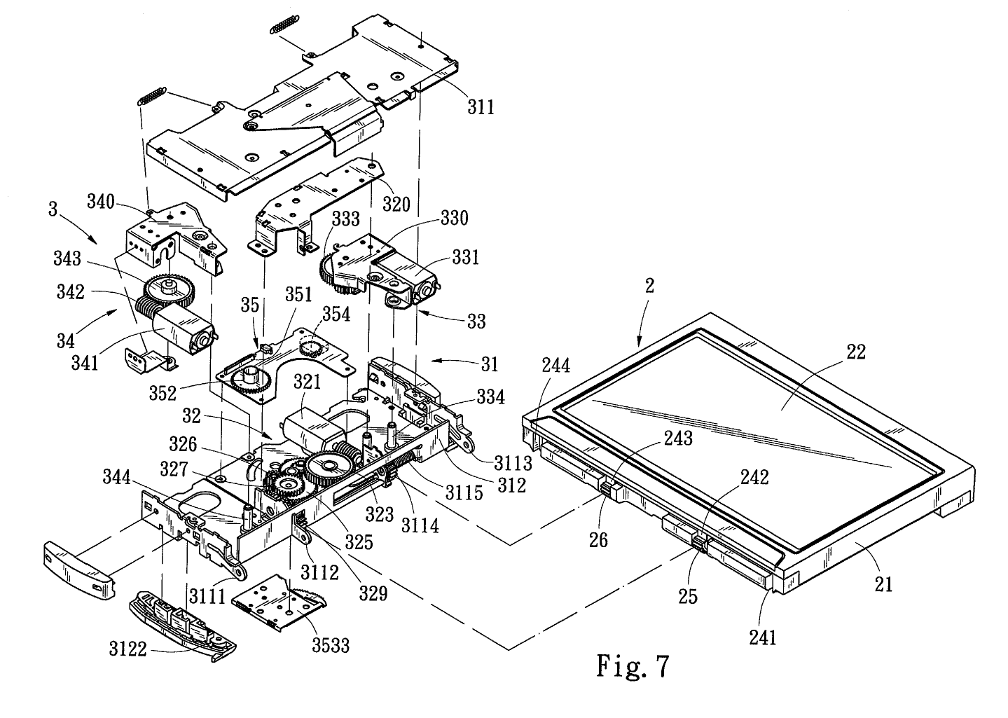

Referring to FIG. 7, the transmission mechanism 3 includes a seat body 31 composed of an upper casing 311 and a lower casing 312. One side of the lower casing 312 is provided with lugs 3111, 3112, 3113 corresponding to the pivot holes 241, 242, 243. The lugs 3111, 3112, 3113 are respectively pivotally mounted in the pivot holes 241, 242, 243, whereby the display panel 2 is pivotally connected with the transmission mechanism 3.

A first gear set 32, a second gear set 33 and a third gear set 34 are disposed on the lower casing 312.

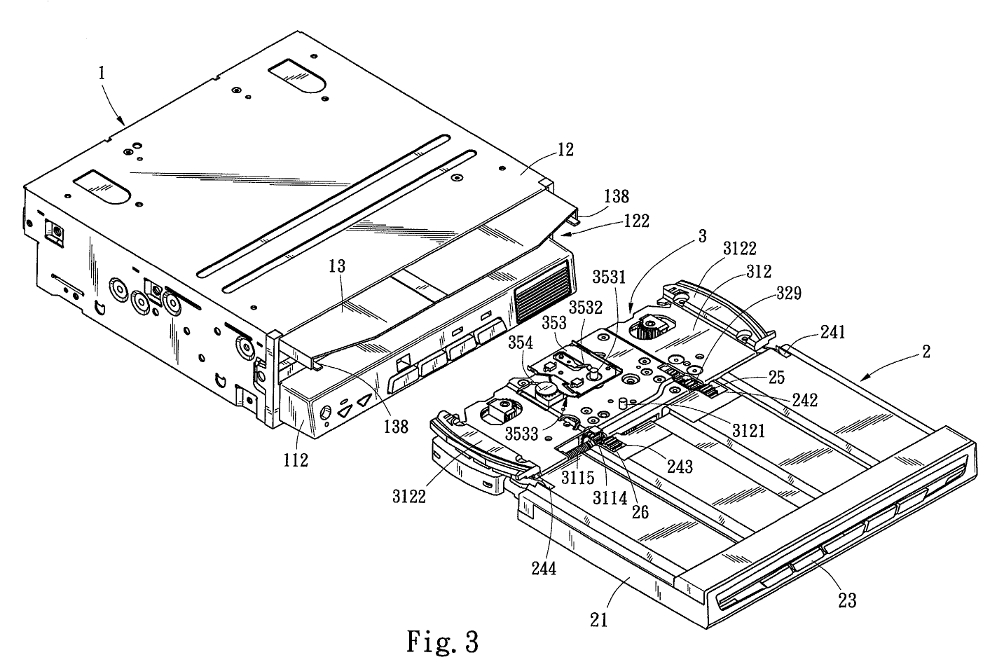

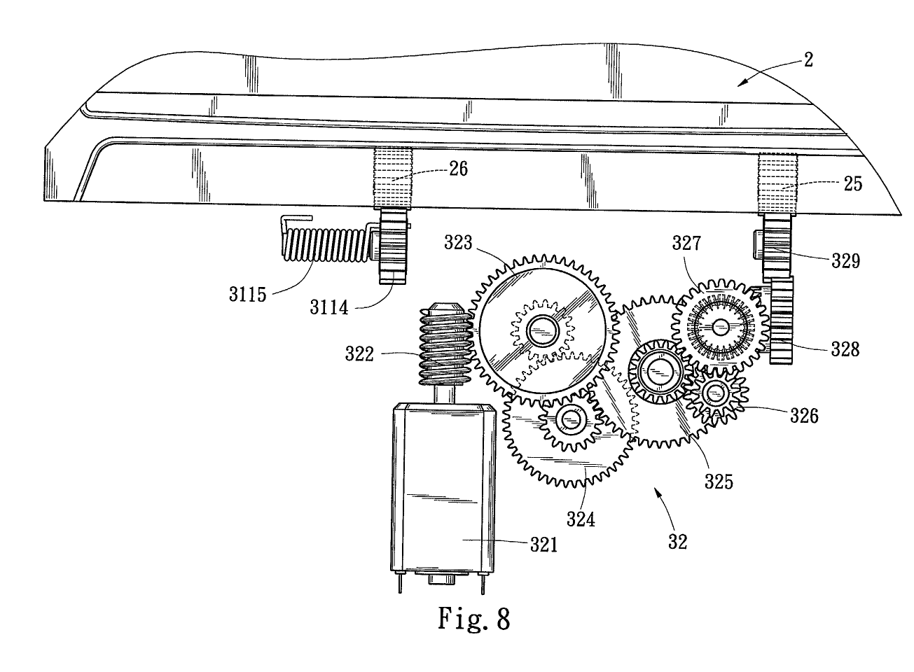

Referring to FIGS. 3 and 8, the first gear set 32 is arranged in a space defined by a shell plate 320 and the lower casing 312. The first gear set 32 includes a power source 321 such as a motor, a spiral gear 322, a main gear 323, a subsidiary gear 324, a driven gear 325, a first driven gear 326, a bevel gear 327, a second driven gear 328 and a third driven gear 329. The spiral gear 322 is fitted on the power source 321. The power generated by the power source 321 is transmitted to sequentially drive the main gear 323, the subsidiary gear 324, the driven gear 325, the first driven gear 326, the bevel gear 327, the second driven gear 328 and the third driven gear 329. The third driven gear 329 extends out of the lower casing 312 to engage with the gear 25 of the display panel 2. By means of the power source 321, the third driven gear 329 is able to drive the gear 25 of the display panel 2 to clockwise or counterclockwise rotate. (That is, the display panel 2 is driven to swing forward downward or swing backward upward.)

Referring to FIGS. 3 and 7, a sensing unit 35 is disposed in a position near the first gear set 32. The sensing unit 35 includes multiple circuit elements 351, a first sensory gear 352, a movable plate 353 and a second sensory gear 354. The movable plate 353 is pivotally mounted on back face of the lower casing 312 near the center thereof. The first sensory gear 352 is engaged with the driven gear 325 for sending the rotational signal of the driven gear 325 to the circuit element 351 for the main circuit control board to take the data of rotational angle. The movable plate 353 is provided with a projecting post 3531, a leaf spring 3532 and a toothed edge 3533 for meshing with the second sensory gear 354.

When the movable plate 353 is swung, the second sensory gear 354 detects the movement of the toothed edge 3533 and via the circuit element 351 sends the signal to the main circuit control board. The projecting post 3531 and the leaf spring 3532 are correspondingly slidably inlaid in the guide channel 136 of the base board 13. A projecting post 3121 is disposed on the lower casing 312 longitudinally corresponding to the projecting post 3531 and slidably inlaid in the guide channel 136 of the base board 13. Two sides of the lower casing 312 and the base board 13 are respectively formed with corresponding slide blocks 3122 and channels 138. The slide blocks 3122 of the lower casing 312 are slidably inlaid in the channels 138 of the base board 13 to serve as guide rails. The second gear set 33 and third gear set 34 mesh with the rack 137 of the base board 13 and the rack 125 of the lower casing 12.

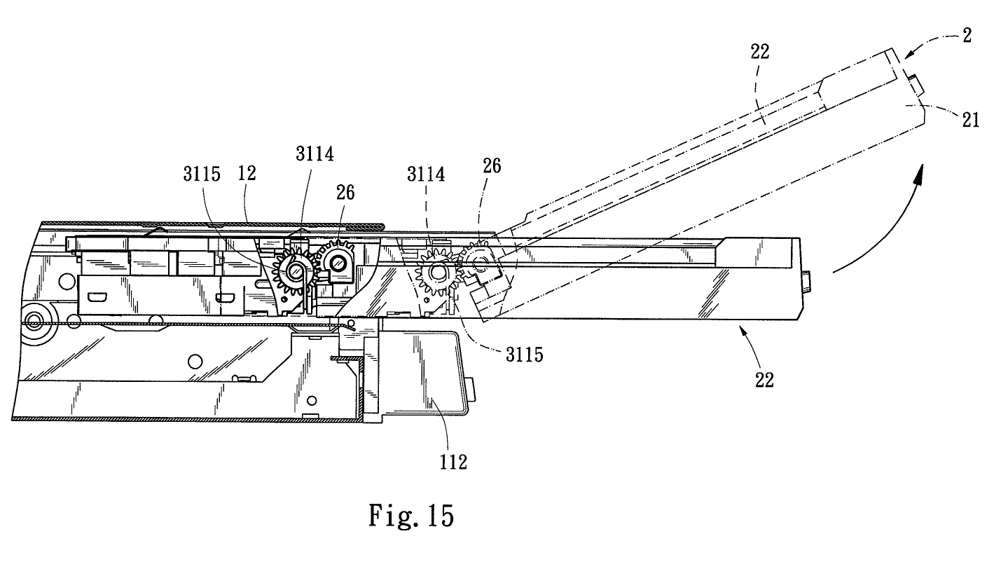

Referring to FIGS. 8 and 15, the lower casing 312 is provided with a back gear 3114 corresponding to the gear 26 of the display panel 2. The back gear 3114 meshes with the gear 26 and is resiliently forced by a resilient body 3115. After the display panel 2 extends out of the housing 1, the back gear 3114 makes the display panel 2 naturally upward swing to reduce the load on the power source 321 for upward swinging the display panel 2.

Referring to FIG. 7, the second gear set 33 and third gear set 34 respectively include movable shell seats 330, 340, power sources 331, 341, spiral gears 332, 342 and driving gears 333, 343 which are mounted on the movable shell seats 330, 340. The movable shell seats 330, 340 are respectively disposed on two sides of the first gear set 32. Shaft members 334, 344 are disposed on the lower casing 312 for pivotally connecting the movable shell seats 330, 340 with the lower casing 312. The power sources 331, 341 via the spiral gears 332, 342 mounted thereon drive the driving gears 333, 343 to rotate. The driving gears 333, 343 downward extend out of the lower casing 312 to mesh with the rack 137 of the base board 13 and the rack 125 of the lower casing 12. Under control of the main circuit, the second gear set 33 and third gear set 34 can synchronously rotate.

Referring to FIGS. 9 and 10, when driven by the power sources 331, 341 of the two gear sets 33, 34, the driving gears 333, 343 can forward or backward rotate. When it is desired to extend the entire display panel 2 out of the housing 1, the main circuit controls the power sources 331, 341 of the two gear sets 33, 34 to simultaneously respectively forward and backward rotate. At this time, the driving gears 333, 343 engaged with the rack 137 of the base board 13 drive the display panel 2 to extend out of the housing 1.

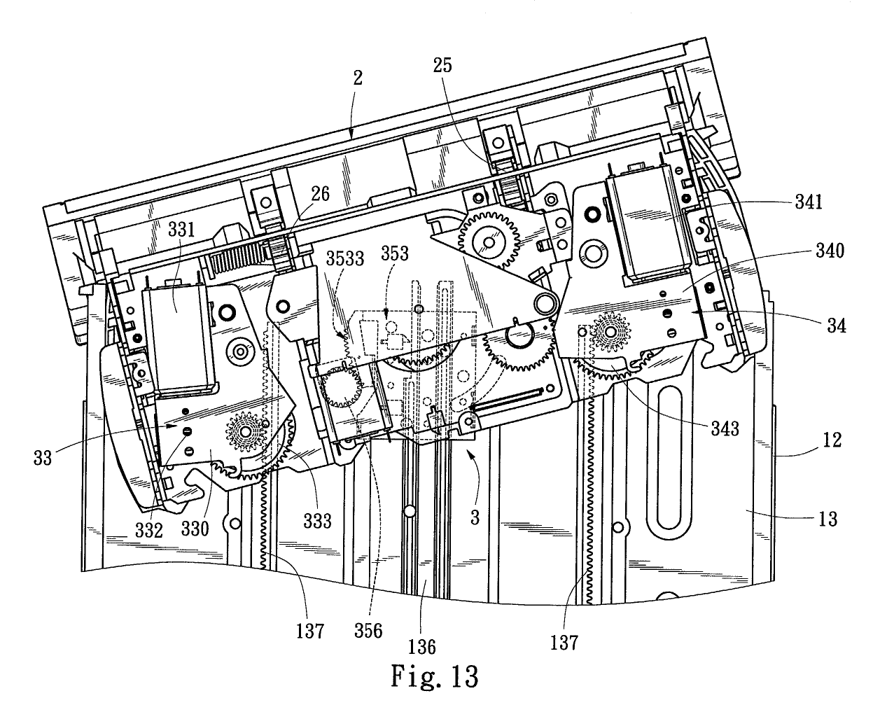

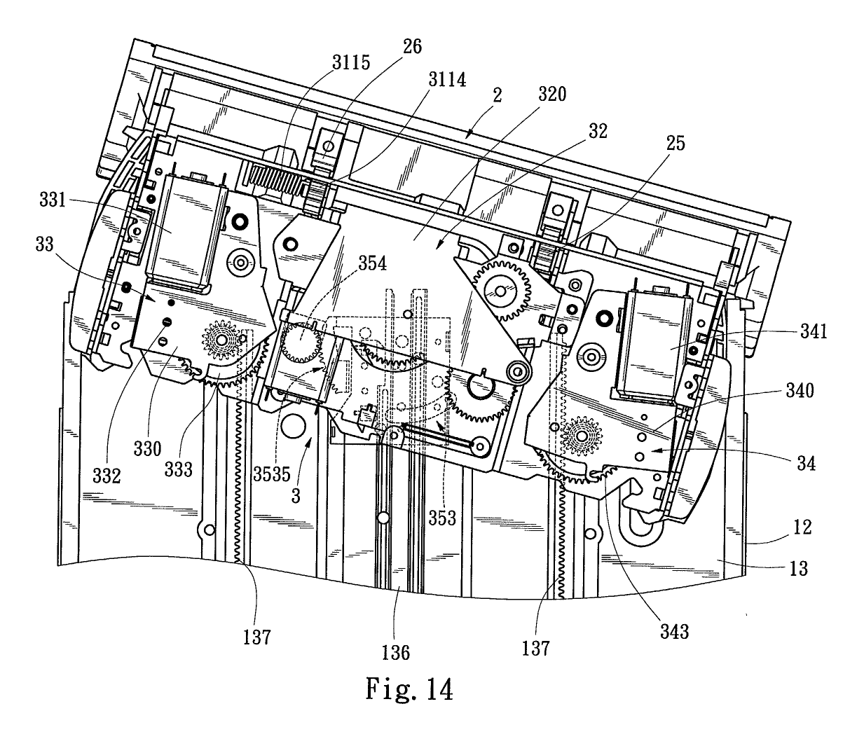

Referring to FIG. 13, after the display panel 2 extends out of the housing 1, the main circuit controls the power source 331, 341 of the second or third gear set 33, 34 to activate. When swinging the display panel 2 leftward, the power source 331 of the second gear set 33 is backward rotated and the power source 341 of the third gear set 34 is forward rotated to complete the operation. Reversely, referring to FIG. 14, when swinging the display panel 2 rightward, the power source 331 of the second gear set 33 is forward rotated and the power source 341 of the third gear set 34 is backward rotated to complete the operation.

When the second gear set 33 and third gear set 34 are swung leftward or rightward, the movable plate 353 under the lower casing 312 is synchronously swung. The swinging signal is detected by the second sensory gear 354.

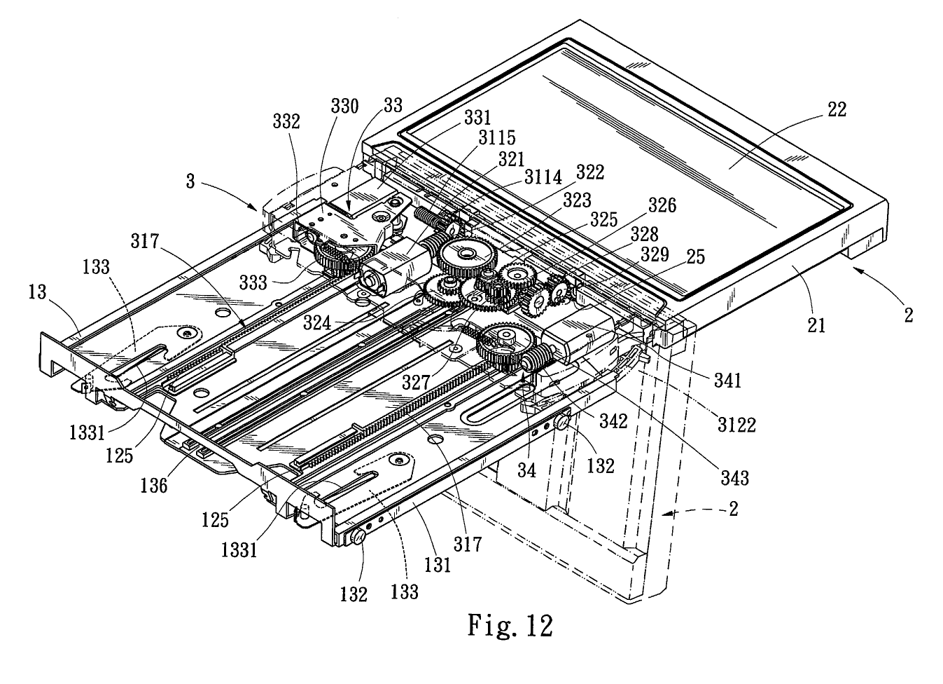

Please refer to FIGS. 9 and 10 which show the complete operation of the present invention. After the main circuit is powered on, a user can control the operation of the display panel 2. When it is desired to extend the display panel 2 forward, the power sources 331, 341 of the second and third gear sets 33, 34 will respectively drive the driving gears 333, 343 to continuously move outward along the rack 137 of the base board 13. At this time, a hooking notch 3123 of the lower casing 312 hooks the press post 135 and the base board 13 is together driven to move outward. When the open end 1342 of the base board 13 moves to a position close to the locating post 124, the guide notch 1331 of the hook body 133 instantaneously hooks and locates the locating post 124, whereby the base board 13 no more slides forward. Referring to FIG. 12, the lower casing 312 continuously drives the display panel 2 to move outward to entirely extend out of the housing 1. Thereafter, the back gear 3114 on the lower casing 312 resiliently makes the display panel 2 naturally upward swing.

Referring to FIG. 13, after the display panel 2 extends out of the housing 1, the main circuit controls the power source 331, 341 of the second or third gear sets 33, 34 to operate, whereby the second and third gear sets 33, 34 are simultaneously respectively moved backward and forward to make the display panel 2 swing leftward. Referring to FIG. 14, when swinging the display panel 2 rightward, the gear sets 33, 34 are reversely operated.

Referring to FIG. 11, when it is desired to retract the display panel 2 into the housing 1, the power sources 331, 341 of the second and third gear sets 33, 34 respectively drive the driving gears 333, 343 to continuously inward move along the racks 137 of the base board 13. At this time, the hooking notch 3123 of the lower casing 312 hooks the press post 135 and the base board 13 is together driven to move inward until the rear sides of the base board 13 and the lower casing 312 move the rear close end of the lower casing 12. At this time, the mechanism is restored to its home position.

According to the above arrangement, the observation angle of the display panel can be easily multidirectionally adjusted.

The above embodiment is only used to illustrate the present invention, not intended to limit the scope thereof. Many modifications of the above embodiment can be made without departing from the spirit of the present invention.

What is claimed is:

1. Display panel transmission structure capable of multidirectionally adjusting observation angle of the display panel, said transmission structure comprising:
a housing including an upper casing and a lower casing, a main circuit control board being received in the upper casing, the upper and lower casings defining a layout space in which the display panel and a transmission mechanism are movably received, a base board being slidably disposed on the lower casing, a transmission guide member being disposed on the base board for guiding the transmission mechanism in sliding;
a display panel in which a liquid crystal unit is disposed, one side of the display panel being drivingly pivotally connected with the transmission mechanism; and
a transmission mechanism composed of several gear sets mounted on a base seat, each gear set being directly or indirectly controlled and driven by at least one motor to drivingly operate multiple gears, one gear set being engaged with a gear disposed in the display panel, whereby by means of rotation of the gear set, the display panel can be swung forward downward or backward upward, at least one gear set being movably assembled with the guide member on the base board, whereby under control of the main circuit control board, the motor can forward and backward operate to simultaneously rotate the gear sets clockwise and counterclockwise so as to extend the display panel out of the housing or retract the display panel into the layout space of the housing, after the display panel being extended out of the housing, the main circuit controlling the motor of a gear set to micro-rotate and make an opposite gear set rotate in the same direction, whereby the display panel is swung leftward or rightward.

2. Display panel transmission structure capable of multidirectionally adjusting observation angle of the display panel as claimed in claim 1, wherein the upper casing is a case defining a receiving space in which the main circuit control board is disposed.

3. Display panel transmission structure capable of multidirectionally adjusting observation angle of the display panel as claimed in claim 2, wherein a control panel is disposed at one end of the receiving space and connected with the main circuit board for a user to touch and control the functions of the display panel.

4. Display panel transmission structure capable of multidirectionally adjusting observation angle of the display panel as claimed in claim 1, wherein the transmission guide member is composed of a rack and a guide channel.

5. Display panel transmission structure capable of multidirectionally adjusting observation angle of the display panel as claimed in claim 1, wherein two sides of the base board are formed with ribs on which slide blocks are disposed, two sides of the lower casing being formed with slide channels corresponding to the slide blocks, the slide blocks being movable within the slide channels, whereby the base board can slide along the slide channels.

6. Display panel transmission structure capable of multidirectionally adjusting observation angle of the display panel as claimed in claim 5, wherein two opposite hook bodies are pivotally disposed on lower side of base board and pulled by resilient members to keep in an inward biased state, inner side of each hook body being formed with a guide notch, the base board being formed with guide slots corresponding to and overlapping the guide notches, each guide slot having a close end and an open end, the lower casing being formed with locating posts respectively corresponding to the sliding positions of the guide notches and guide slots, whereby when the base board is slided and retracted into the housing, the close ends of the guide slots abut against the locating posts to restrict the base board, and reversely, when the base board is slided outward from the housing and the open ends of the guide slots are moved to get close to the locating posts, the guide notches of the hook bodies instantaneously hook and locate the locating posts.

7. Display panel transmission structure capable of multidirectionally adjusting observation angle of the display panel as claimed in claim 6, wherein each hook body has a press post, whereby by means of shifting the press posts in a direction reverse to the hooking direction, the locating posts are released from the hooking of the hook bodies.

8. Display panel transmission structure capable of multidirectionally adjusting observation angle of the display panel as claimed in claim 1, wherein two racks are disposed on the lower casing corresponding to the two racks of the base board, whereby the racks of the lower casing can extend out from the base board and overlap the racks thereof to cooperatively extend the travel.

9. Display panel transmission structure capable of multidirectionally adjusting observation angle of the display panel as claimed in claim 1, wherein the bottom of the display panel is formed with multiple pivot holes, the transmission mechanism being pivotally connected at several pivot holes of the multiple pivot holes and gears being mounted at at least one of the pivot holes.

10. Display panel transmission structure capable of multidirectionally adjusting observation angle of the display panel as claimed in claim 1, wherein the multiple gear sets of the transmission mechanism include a first, a second and a third gear sets.

11. Display panel transmission structure capable of multidirectionally adjusting observation angle of the display panel as claimed in claim 1, wherein transmission mechanism includes a seat body composed of an upper casing and a lower casing, one side of the lower casing being provided with lugs corresponding to the pivot holes of the display panel, the lugs being respectively pivotally mounted in the pivot holes, whereby the display panel is pivotally connected with the transmission mechanism.

12. Display panel transmission structure capable of multidirectionally adjusting observation angle of the display panel as claimed in claim 11, wherein two sides of the lower casing and the base board are respectively formed with corresponding slide blocks and channels, the slide blocks of the lower casing being slidably inlaid in the channels of the base board to serve as guide rails, the second gear set and third gear set meshing with the rack of the base board and the rack of the lower casing.

13. Display panel transmission structure capable of multidirectionally adjusting observation angle of the display panel as claimed in claim 11, wherein the lower casing is provided with a back gear corresponding to the gear of the display panel, the back gear meshing with the gear of the display panel and being resiliently forced by a resilient body, whereby after the display panel extends out of the housing, the back gear makes the display panel naturally upward swing.

14. Display panel transmission structure capable of multidirectionally adjusting observation angle of the display panel as claimed in claim 10, wherein on the lower casing of the seat body are disposed a first, a second and a third gear sets for driving the display panel to slide and extend or swing.

15. Display panel transmission structure capable of multidirectionally adjusting observation angle of the display panel as claimed in claim 10, wherein the second gear set is disposed on a movable shell seat, a power source, a spiral gear and a driving gear being mounted on the movable shell seat, a shaft member being disposed on the lower casing for pivotally connecting the movable shell seat with the lower casing.

16. Display panel transmission structure capable of multidirectionally adjusting observation angle of the display panel as claimed in claim 15, wherein the driving gear of the second gear set downward extends out of the lower casing to mesh with the rack of the base board and the rack of the lower casing, the driving gear being driven by the power source to rotate along the racks so as to extend the display panel out of the housing or retract the display panel into the layout space of the housing.

17. Display panel transmission structure capable of multidirectionally adjusting observation angle of the display panel as claimed in claim 10, wherein the third gear set is disposed on a movable shell seat, a power source, a spiral gear and a driving gear being mounted on the movable shell seat, a shaft member being disposed on the lower casing for pivotally connecting the movable shell seat with the lower casing.

18. Display panel transmission structure capable of multidirectionally adjusting observation angle of the display panel as claimed in claim 17, wherein the driving gear of the third gear set downward extends out of the lower casing to mesh with the rack of the base board and the rack of the lower casing, the driving gear being driven by the power source to rotate along the racks so as to extend the display panel out of the housing or retract the display panel into the layout space of the housing.

19. Display panel transmission structure capable of multidirectionally adjusting observation angle of the display panel as claimed in claim 10, wherein a hooking notch is formed on the lower casing, whereby when the lower casing is moved out of the housing, the hooking notch hooks the press post of the hook body so that the base board is together driven to move outward.

20. Display panel transmission structure capable of multidirectionally adjusting observation angle of the display panel as claimed in claim 10, wherein the first gear set is arranged in a space defined by a shell plate and the lower casing, the first gear set including a power source, a spiral gear, a main gear, a subsidiary gear, a driven gear, a first driven gear, a bevel gear, a second driven gear and a third driven gear, the spiral gear being fitted on the power source, the power generated by the power source being transmitted to sequentially drive the main gear, the subsidiary gear, the driven gear, the first driven gear, the bevel gear, the second driven gear and the third driven gear, the third driven gear extending out of the lower casing to engage with the gear of the display panel.

21. Display panel transmission structure capable of multidirectionally adjusting observation angle of the display panel as claimed in claim 20, wherein a sensing unit is disposed beside the first gear set, the sensing unit including multiple circuit elements, a first sensory gear, a movable plate and a second sensory gear, the movable plate being pivotally mounted on back face of the lower casing near the center thereof, the first sensory gear being engaged with the driven gear for sending the rotational signal of the driven gear to the circuit elements for the main circuit control board to take the data of rotational angle, the movable plate being provided with a projecting post, a leaf spring and a toothed edge for meshing with the second sensory gear, whereby when the movable plate is swung, the second sensory gear detects the movement of the toothed edge and via the circuit elements sends the signal to the main circuit control board, the projecting post and the leaf spring being correspondingly slidably inlaid in the guide channel of the base board, a projecting post being disposed on the lower casing longitudinally corresponding to the projecting post of the movable plate and slidably inlaid in the guide channel of the base board.
